(19) United States
(12) Patent Application Publication
(10) Pub. No.: US 2022/0343402 A1
(43) Pub. Date: Oct. 27, 2022

(54) GREY MARKET ORDERS DETECTION

(71) Applicant: EMC IP Holding Company LLC, Hopkinton, MA (US)

(72) Inventors: Or Herman Saffar, Ofakim (IL); Noga Gershon, Beer Sheva (IL)

(21) Appl. No.: 17/237,561

(22) Filed: Apr. 22, 2021

(51) Int. Cl. G06Q 30/06; G06Q 30/02; G06N 20/00

(52) U.S. Cl. CPC G06Q 30/0637; G06Q 30/0204; G06Q 30/0609; G06N 20/00

(57) ABSTRACT

One example method includes detecting grey market orders with a detection model. Data from historical orders, which include confirmed grey market orders, can be clustered based on engineered features of the data. A new order can be assigned to one of the clusters based on similarity and a score for the new order can be generated that reflects the likelihood that the new order is a grey market order. Action can be taken on the new order based on the score. The scores output by the detection model can be reviewed such that user input regarding the scores can be used to retrain the detection model.

### FIELD OF THE INVENTION

Embodiments of the present invention generally relate to detecting grey market orders. More particularly, at least some embodiments of the invention relate to systems, hardware, software, computer-readable media, and methods for detecting grey market orders and for acting on the detection of grey market orders.

### BACKGROUND

The term “grey market” often refers to the trade of commodities through distribution channels that are not authorized by the original manufacturer. S grey market order generally refers to an order where the purchased product is resold in an unauthorized manner. The initial grey market order may be through an authorized channel.

More specifically, unauthorized resellers are able to purchase the product at a price that allows them to make a profit by reselling the product at prices that are attractive to other consumers. This impacts the manufacturer in many ways, including financially.

In addition to the financial impact of the grey market, grey market sales can lead to problems for a brand. For example, the availability of product in the grey market may cause customers to purchase from an unauthorized reseller. However, these types of sales in the grey market may come with incompatible equipment, instructions in a foreign language, or the like. Unfortunately, the manufacturer and/or authorized resellers are often blamed for these problems. Plus, customers may also begin to expect the discount available in the grey market.

Currently, grey market orders are detected after the fact. There is no ability to detect when a purchaser (who may or may not be the reseller) is going to resell the purchased product in an unauthorized manner at the time the order is placed.

Grey market orders may not be detected for some time. One of the ways companies detect grey market orders is by using a buy-back program. A manufacturer can purchase products that are sold through an unauthorized channel and trace the product to the account that made the purchase. The characteristics of that grey market order can then be determined. However, this does not necessarily help the manufacture to detect a grey market order at the time of purchase. Currently, the ability to detect grey market orders is a difficult and manual process and there is no ability to take action against grey market orders at the time the order is placed or while the order is being prepared.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a model configured to detect grey market orders and the ability to update or retrain the model based on feedback regarding the model's output;

FIG. 2 discloses aspects of a clustering engine and an analytic engine of a model configured to detect grey market orders;

FIG. 3 discloses aspects of a method for detecting a grey market order; and

FIG. 4 discloses aspects of a physical computing device or system.

### DETAILED DESCRIPTION OF SOME EXAMPLE EMBODIMENTS

Embodiments of the present invention generally relate to operations related to purchasing products and services. More particularly, at least some embodiments of the invention relate to systems, hardware, software, computer-readable media, and methods for detecting grey market orders and for acting on grey market orders.

The ability to detect a grey market order while the order is being placed or fulfilled allows a seller or manufacturer to take actions prior to completing the order. Embodiments of the invention relate to, in addition to detecting a grey order, preventing the order, not approving the order, adjusting the order (e.g., in terms of quantity, price, discount applied), or the like or combination thereof. Embodiments of the invention may detect grey orders, rank grey market orders based on their importance or availability, or the like.

In some embodiments, machine learning plays a role in detecting grey market orders. A detection model (e.g., a machine learning model) may include multiple engines or components and can be trained with historical data (data associated with legitimate and/or grey market orders). The data used to train a model may include characteristics or features of the orders. The features may be extracted or generated from the raw order data. Embodiments of the invention may also discover which of the features are more relevant in distinguishing or differentiating grey market orders from legitimate orders. In other words,

Some features may be engineered to capture or identify behavior in an order or in an account that indicates the occurrence of grey market activity. Embodiments of the invention can generate a score for a new order based, by way of example only, on the similarity of the new order to confirmed grey market orders using features that are built or engineered to identify grey market activity.

In addition to a detection model configured to detect grey market orders that is trained on historical data, embodiments of the invention augment the training or retrain the model using user or analyst feedback. In effect, embodiments of the invention allow the model to be trained using weights including both user-defined or adjusted weights and machine learned weights. User feedback, for example, can be used to adjust the weights in the detection model via retraining.

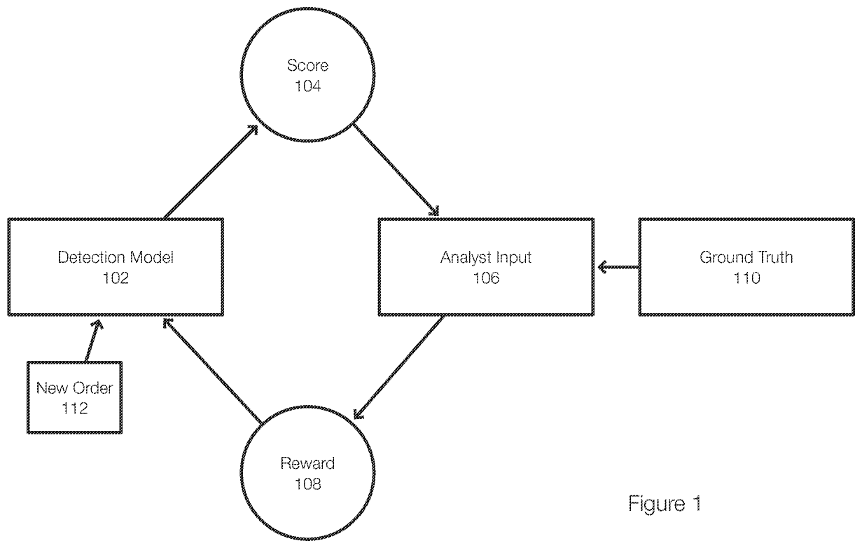

FIG. 1 illustrates an example of a process for retraining a model that, in one example, was already trained using historical data. In this example, a detection model 102 may have been generated and trained on historical data. In this example, the detection model 102 may generate scores for new orders (e.g., a score 104 for a new order 112) by running the new order 112 through the trained model 102.

An analyst may provide input 106 related to the score 104 (and for other scores generated by the model 102). The input 106 may be based on ground truth 110. In one example, the ground truth 110 may be the analyst's view of the new order 112. Thus, an analyst may review the score 104 to determine, for example, whether the score 104 is accurate and reflects whether the new order 112 is a legitimate order or a grey market order. In other words, an analyst can determine whether the score 104 is accurate based on, for example, an analysis of the corresponding order 112. This ground truth 110 can be used to generate a reward 108 or feedback. Thus, the input 106 is a reward 108 or other data that is used to retrain the model 102. This is an example of reinforcement learning and allows weights of the model 102 to be adjusted based on machine learning (e.g., unsupervised learning) or using expert defined weights.

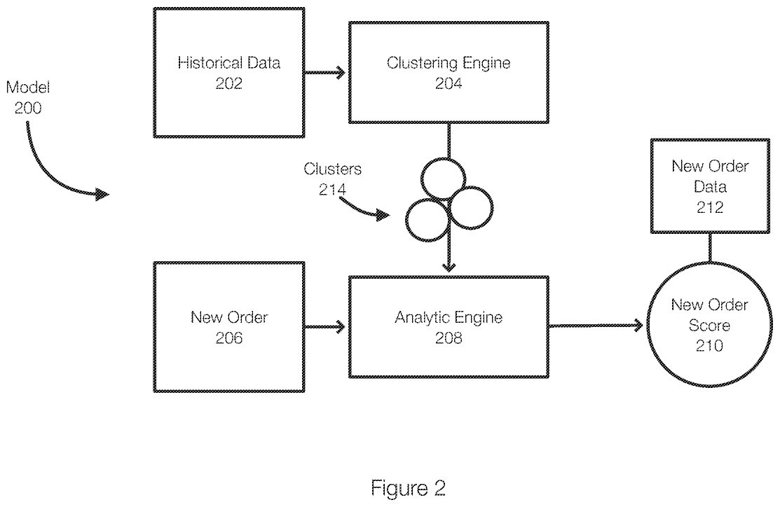

FIG. 2 discloses aspects of a grey order detection model. The model 200 may include various engines including, by way of example only, a clustering engine 204 and an analytic engine 208. The model 200 uses statistical methods and machine learning methods to automatically detect grey market orders. In one example, a new order 206 is input to the model 200 and a new order score 210 is output by the model 200. The new order score 210 may be associated with new order data 212, such as insights that may be used to handle the new order 206. The new order data 212 may also include historical data or historical data of the cluster to which the new order 206 is assigned.

The model 200 may be trained using historical data 202, which corresponds to previous orders. The historical data 202 may include data for legitimate orders and/or for grey market orders. The clustering engine 204 is configured to generate clusters 214 from the historical data 202. The clustering engine 204 groups the historical data 202, which includes confirmed grey market orders, into the clusters 214 using various features. Thus, each of the clusters 214 represents a group of similar orders.

More specifically, the historical data 202 may be processed to generate features that are input to the clustering engine 204. Example features include, but are not limited to, one or more of: discount of list price, buy power (amount of goods and services of a company that can be purchased with a unit of currency), last n quarters peripherals to systems ratio (e.g., n=4), quote system units, goal peripherals units, goallite peripherals units, goal system units, goallite system units, total number of employees, account type (direct/indirect), one account (purchase include one account or more), last n quarters peripherals to employee ratio (e.g., n=4), account description (e.g., company main business). In this example, “goallite” refers to order up to a threshold value (e.g., 2 million) and “goal” refers to orders above the threshold.

These features can be generated, extracted, or derived from the raw historical data 202 and used by the clustering engine 204 to generate clusters 214. In one example, the clustering engine 204 is an unsupervised learning task that divides a set of data points into several groups in such a way that data points assigned to the same group of cluster are more similar to data points in the same group than those in other groups. Example clustering techniques include k-means, Gaussian mixture model, or hierarchical clustering.

In one example, the clusters generated by the clustering engine 204 may each represent a different behavior or type of grey market orders. In other words, features generated from the historical data 202 are input to the clustering engine 204 and the clustering engine 204 then produces clusters 214. Each cluster may represent similar orders. In one example, each cluster may represent similar grey market orders. When a new order is determined to be similar to orders in one of the clusters, the new order is assigned to the cluster and a score can be generated based, at least in part, on the cluster to which the new order is assigned.

The number of clusters generated by or associated with the clustering engine 204 can vary and can be changed. In one example, a metric is used to determine the number of clusters. The metric, in one example, is an adjusted inertia metric that is defined as follows:

$$Adjusted intertia = \frac{Inertia ( K )}{Inertia ( K = 1 )} + α K$$

In this example, Inertia is a sum of squared distances of samples to their closest cluster center. Alpha (α) is a manually tuned factor that gives a penalty to the number of clusters. The adjusted inertia is a minimal for an optimal number of clusters.

In one example, the clustering engine processes the historical data 202 or the features generated from the historical data 202 to generate clusters 214 that can be used by an analytic engine 208.

When a new order 206 is generated or made, the new order 206 is processed, similarly to the historical data 202 to generate the same features. The analytic engine 208 can then assign or associate the new order 206 to one of the clusters 214 based on the features of the new order 206.

After the new order 206 is assigned to a cluster, a score 210 is generated for the new order 206. The new order 206 is assigned to a cluster because, in one example, each cluster has a different parameter. Thus, each cluster is associated with a cluster parameter. The cluster parameter describes a ratio between the number of confirmed grey market orders in the cluster to the total number of confirmed grey market orders in the cluster or in all of the clusters. In some embodiments, the historical data may include both legitimate and grey market orders and the clusters may represent both legitimate and great market orders.

Next, a score of the new order is determined by assessing the similarities between the new order and the confirmed grey market orders inside the assigned cluster for the new order. In one example, similarity is determined using a cosine similarity measurement. The final score 210 of the new order 206 is based on these parameters as follows:

Order's Score=CS_{S}*CS_{W}+CL_{S}*CL_{W}

In this example:

CS_{S} is the maximum cosine similarity score;

CS_{W} is a weight for the maximum cosine similarity score;

CL_{S} is a score describing the ratio for the assigned cluster; and

CL_{W} is a weight for the ratio cluster score.

The initial weight of each component may be determined by a user based on historical behavior and knowledge. The weights can be adjusted during training based on input from an analyst and on other data.

As described with respect to FIG. 1, a user such as an analyst may provide feedback that can be used to retrain the model using reinforcement learning. In one example, reinforcement learning allows the model to generate scores for new orders based on the initial weights. An analyst (e.g., a pricing analysist) may compare the generated scores against the analyst's ground truth (based on the analyst's experience) to determine how well the model performed.

The analyst may provide feedback for the generated score on a scale from 0 to 1. If the feedback is closer to 1, the model may be updated to generate similar outputs for these types of orders. If the number is closer to 0, the model may be penalized and change its weights to prevent similar scorings. This feedback or rewards are considered when updating the weight values of the machine learning model.

When several new orders are being placed, a list of orders, sorted by score, may be provided to a user. The order that has the highest probability of being a grey market order may thus be prioritized for handling. The users may also obtain information identifying the features that contributed most to the final score 210. This allows users to understand aspects of ordering that can be further investigated.

Thus, the analytic engine 208 takes the characteristics or features of a new order 206 and returns a score 210 indicating a probability or likelihood that the new order 206 is a grey market order based on the score, which in one example is related to the cluster to which the new order is assigned. The analytic engine 208 can detect orders that are similar to well-known or confirmed historical grey market orders. Further, this allows grey market orders to be detected before the orders are approved or completed such that appropriate action can be taken regarding the order. This further allows the time and cost of pricing analysts to be used more effectively and more efficiently and to focus on orders that are more likely to be grey market orders and to focus on the features or characteristics that led to the determination.

As previously discussed, cosine similarity is an example of a manner in which similarity between two feature vectors can be measured and is equal to the cosine of the angle between the two vectors. Two vectors with the same orientation have a cosine similarity of 1, two vectors oriented at 90 degrees relative to each other have a similarity of 0 and diametrically opposed vectors have a similarity of −1. The cosine similarity may be used in positive space and the outcome may be bounded by [0,1]. For example, using feature vectors, the cosine similarity may be defined as:

$$similarity = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

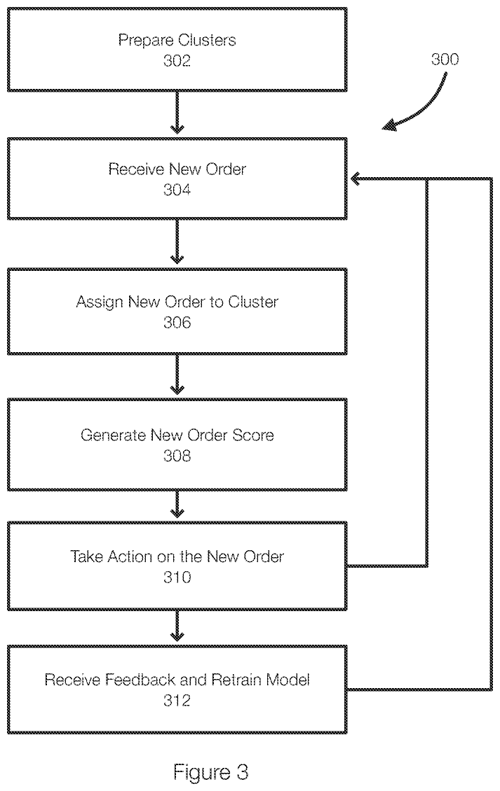

FIG. 3 discloses aspects of a method for detecting grey market orders. Some of the elements in the method 300 may be performed as needed or less often than other elements. For example, once a model is trained on historical data and clusters are generated, regenerating clusters or changing the number of clusters or updating the model with new historical data, may be performed less frequently.

In this example of the method 300, clusters are prepared 302. Clusters are prepared from historical data or, more specifically, from features that have been extracted from the historical data. These features allow historical orders to be clustered. The clusters may represent different types of grey market orders. For example, grey market orders may be based on different features and the clusters can group these different types of orders into appropriate clusters at least for grey market order detection. The number of clusters can be user determined or automatically determined.

Once the clusters have been generated, the detection model, which may also include an analytic engine, may receive 304 a new order. The new order is assigned 306 to a cluster (e.g., by the clustering engine). Assigning 306 the new order to a cluster may include extracting the features of the new order and then assigning the new order to the cluster that includes the most similar orders to the new order.

Once assigned to a cluster, a score is generated for the new order. The score is output and represents the likelihood that the new order is a grey market order. The score may also be associated with metadata identifying the most relevant features that contributed to the generated score.

Action may then be taken 310 on the new order. If the score suggests that the order is legitimate, no action may be taken and the order may be accepted. If the score suggests that the order is a grey market order, actions may be taken 310 such as cancelling the order, changing pricing, limiting quantities, or the like or combination thereof.

In one example, feedback may be received 312 that can be used to retrain the model. The feedback may indicate the accuracy or reliability of a particular score and may be generated by an analyst. This allows the model to use the feedback to update weights such that outputs for future orders reflect the feedback and more accurately identify the order as a grey market order or as a legitimate order.

Embodiments of the invention, such as the examples disclosed herein, may be beneficial in a variety of respects. For example, and as will be apparent from the present disclosure, one or more embodiments of the invention may provide one or more advantageous and unexpected effects, in any combination. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, order detection operations. Such order detection operations may include, but are not limited to, grey market detection operations, clustering operations, feature engineering operations, feature extraction operations, score generation operations, feedback operations, machine learning operations, machine learning training operations, or the like or combination thereof. More generally, the scope of the invention embraces any operating environment in which the disclosed concepts may be useful.

New and/or modified data collected and/or generated in connection with some embodiments, may be stored in a data environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example. Embodiments of the invention may further operate or be embodied in containers and operate in containerized environments and container orchestration systems.

It is noted with respect to the example method of Figure(s) XX that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising performing, by a detection model:

receiving a new order for a product, assigning the new order to a cluster based on features of the new order, wherein the new order is similar to orders associated with the cluster, generating a score for the new order based in part on the assigned cluster, wherein the score is a likelihood that the new order is a grey market order, and taking an action on the new order when the new order is a grey market order.

Embodiment 2. The method of embodiment 1, further comprising generating a plurality of clusters including the cluster from historical data that includes data related to legitimate orders and grey market orders.

Embodiment 3. The method of embodiment 1 and/or 2, further comprising generating features from the historical data, inputting the features into a clustering engine, wherein the clustering engine generates the plurality of clusters from the features.

Embodiment 4. The method of embodiment 1, 2, and/or 3, wherein the features include one or more of: discount of list price, buy power, last n quarters peripherals to systems ratio, quote system units, goal peripherals units, goallite peripherals units, goal system units, goallite system units, total number of employees, account type, one account, last n quarters peripherals to employee ratio, and/or account description.

Embodiment 5. The method of embodiment 1, 2, 3, and/or 4, wherein the score is based on a maximum cosine similarity score, a weight of the maximum cosine similarity score, a score describing a ratio for the assigned cluster, and a weight for the ratio of the assigned cluster, wherein the ratio is a ratio of grey market orders in the assigned cluster to total grey market orders in the plurality of clusters.

Embodiment 6. The method of embodiment 1, 2, 3, 4, and/or 5, wherein further comprising receiving user input for the score, wherein the user input is based on a ground truth of the user.

Embodiment 7. The method of embodiment 1, 2, 3, 4, 5, and/or 6, wherein further comprising retraining the detection model with the user input.

Embodiment 8. The method of embodiment 1, 2, 3, 4, 5, 6, and/or 7, wherein the action includes one or more of cancelling the order, changing a price of the order, taking no action, or limiting a quantity of the order.

Embodiment 9. The method of embodiment 1, 2, 3, 4, 5, 6, 7, and/or 8, wherein further comprising identifying specific features in the features of the new order that contributed most to the score.

Embodiment 10. The method of embodiment 1, 2, 3, 4, 5, 6, 7, 8, and/or 9, wherein further comprising adjusting weights of the detection model based on user input and based on unsupervised learning.

Embodiment 11. A method for performing any of the operations, methods, or processes, or any portion of any of these or any combination thereof, disclosed herein.

Embodiment 12. A non-transitory storage medium having stored therein instructions that are executable by one or more hardware processors to perform operations comprising the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

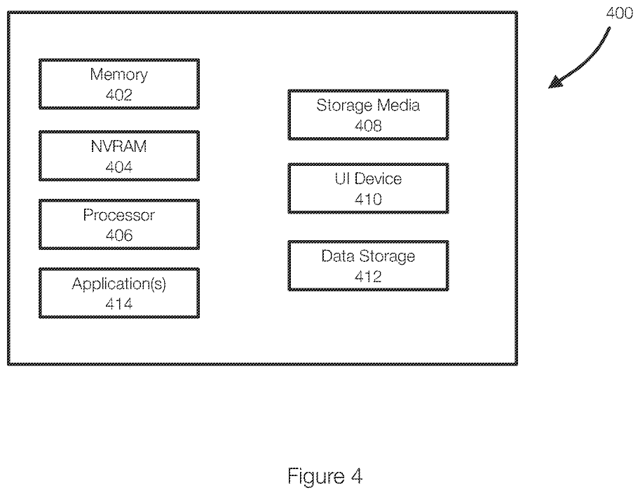

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random-access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
performing, by a detection model:
receiving a new order for a product;
assigning the new order to a cluster based on features of the new order, wherein the new order is similar to orders associated with the cluster;
generating a score for the new order based in part on the assigned cluster, wherein the score is a likelihood that the new order is a grey market order; and
taking an action on the new order when the new order is a grey market order.

2. The method of claim 1, further comprising generating a plurality of clusters including the cluster from historical data that includes data related to legitimate orders and grey market orders.

3. The method of claim 2, further comprising generating features from the historical data, inputting the features into a clustering engine, wherein the clustering engine generates the plurality of clusters from the features.

4. The method of claim 3, wherein the features include one or more of: discount of list price, buy power, last n quarters peripherals to systems ratio, quote system units, goal peripherals units, goallite peripherals units, goal system units, goallite system units, total number of employees, account type, one account, last n quarters peripherals to employee ratio, and/or account description.

5. The method of claim 1, wherein the score is based on a maximum cosine similarity score, a weight of the maximum cosine similarity score, a score describing a ratio for the assigned cluster, and a weight for the ratio of the assigned cluster, wherein the ratio is a ratio of grey market orders in the assigned cluster to total grey market orders in the plurality of clusters.

6. The method of claim 1, further comprising receiving user input for the score, wherein the user input is based on a ground truth of the user.

7. The method of claim 6, further comprising retraining the detection model with the user input.

8. The method of claim 1, wherein the action includes one or more of cancelling the order, changing a price of the order, taking no action, or limiting a quantity of the order.

9. The method of claim 1, further comprising identifying specific features in the features of the new order that contributed most to the score.

10. The method of claim 1, further comprising adjusting weights of the detection model based on user input and based on unsupervised learning.

11. A non-transitory storage medium having stored therein instructions that are executable by one or more hardware processors to perform operations comprising:
performing, by a detection model:
receiving a new order for a product;
assigning the new order to a cluster based on features of the new order, wherein the new order is similar to orders associated with the cluster;
generating a score for the new order based in part on the assigned cluster, wherein the score is a likelihood that the new order is a grey market order; and
taking an action on the new order when the new order is a grey market order.

12. The non-transitory storage medium of claim 11, further comprising generating a plurality of clusters including the cluster from historical data that includes data related to legitimate orders and grey market orders.

13. The non-transitory storage medium of claim 12, further comprising generating features from the historical data, inputting the features into a clustering engine, wherein the clustering engine generates the plurality of clusters from the features.

14. The non-transitory storage medium of claim 13, wherein the features include one or more of: discount of list price, buy power, last n quarters peripherals to systems ratio, quote system units, goal peripherals units, goallite peripherals units, goal system units, goallite system units, total number of employees, account type, one account, last n quarters peripherals to employee ratio, and/or account description.

15. The non-transitory storage medium of claim 14, wherein the score is based on a maximum cosine similarity score, a weight of the maximum cosine similarity score, a score describing a ratio for the assigned cluster, and a weight for the ratio of the assigned cluster, wherein the ratio is a ratio of grey market orders in the assigned cluster to total grey market orders in the plurality of clusters.

16. The non-transitory storage medium of claim 11, further comprising receiving user input for the score, wherein the user input is based on a ground truth of the user.

17. The non-transitory storage medium of claim 16, further comprising retraining the detection model with the user input.

18. The non-transitory storage medium of claim 11, wherein the action includes one or more of cancelling the order, changing a price of the order, taking no action, or limiting a quantity of the order.

19. The non-transitory storage medium of claim 11, further comprising identifying specific features in the features of the new order that contributed most to the score.

20. The non-transitory storage medium of claim 11, further comprising adjusting weights of the detection model based on user input and based on unsupervised learning.
